(19) United States
(12) Patent Application Publication
(10) Pub. No.: US 2005/0114496 A1
(43) Pub. Date: May 26, 2005

(54) Method and apparatus for monitoring network connectivity between a home network device and a network

(76) Inventors: Zheng Fang, North Wales, PA (US); Evan A. Groat, Lansdale, PA (US); Yucheng Jin, Chalfont, PA (US)

Correspondence Address: Kin-Wah Tong, Esq.;Moser, Patterson & Sheridan, L.L.P, Suite 100, 595 Shrewsbury Avenue, Shrewsbury, NJ, 07702, US

(21) Appl. No.: 10/698,186

(22) Filed: Oct. 31, 2003

(51) Int. Cl. G06F 15/173

(52) U.S. Cl. 709/224

(57) ABSTRACT

A method and apparatus for monitoring network connectivity between a home network device (100) and a network (102, 104) is described. In one example, status of a network connection on a physical data link (116, 120) between the home network device (100) and the network (102, 104) is determined. A visual indicator (114, 130) is then generated at the home network device (100) indicative of the status of the network connection.

### BACKGROUND OF THE INVENTION

1. Field of the Invention

The present invention generally relates to computer networks and, more particularly, to monitoring network connectivity between a home network device and a network.

2. Description of the Related Art

Network devices for the home or small office/home office (SOHO) environment (hereinafter referred to as “home network devices”) typically monitor the physical connection to devices with which they communicate. That is, a home network device monitors the cables, connectors, modem circuitry, and the like that form a physical circuit, as well as the transmission protocol used to physically transmit signals over the physical circuit. The physical circuit and the transmission protocol used to transmit signals over the physical circuit are referred to herein as a “physical data link” or “data link”. For example, a router for the SOHO environment may include a light-emitting diode (LED) to verify the integrity of twisted pair cable (e.g., category 5 cable) connection between the router and a modem, and the functionality of the transmission protocol (e.g., 10Base-T or 100Base-T) used to transmit signals over the twisted pair cable. Likewise, a modem for the SOHO environment may include an LED to verify the integrity of the twisted pair cable or coaxial cable connection between the modem and a service provider, and the functionality of the digital subscriber line (DSL) or Data Over Cable Service Interface Specification (DOCSIS) transmission protocol.

The LEDs that indicate physical connectivity status may be misleading to the typical user of a home network device. For example, the LED on a router that monitors physical connectivity status is typically identified with the label WAN, which stands for wide area network. The user may mistakenly believe the WAN LED on the router indicates the status of an Internet connection or a connection to the wide area network of an Internet Service Provider (ISP) (hereinafter referred to as a “network connection”). A network connection is typically implemented using a transmission control protocol/internet protocol (TCP/IP) that is encapsulated by the transmission protocol of the physical data link. The network connection facilitates communication between the various hosts of the wide area network/Internet and the user's the local area network (e.g., routing, bridging, transmission, and control of data packets). In contrast, the physical transmission protocol is solely concerned with the physical transmission of signals over the transmission medium (e.g., modulation of signals and representation of data bits).

The user may be unaware that the WAN LED is only associated with the physical data link between the router and the modem, and not the network connection to the ISP. This may lead to confusion, especially when the physical data link between the router and the modem is functioning, but the wide area network of the ISP is out-of-service (e.g., the TCP/IP connection is not functioning). Moreover, present home network devices, such as routers, modems, and the like, do not monitor the network connection to networks with which they communicate and do not display such network connectivity to the user. Accordingly, there exists a need in the art for a method and apparatus that monitors network connectivity between a home network device and a network.

### SUMMARY OF THE INVENTION

A method and apparatus for monitoring network connectivity between a home network device and a network is described. In one embodiment of the invention, status of a network connection on a physical data link between the home network device and the network is determined. For example, the network connection may be implemented using transmission control protocol/internet protocol (TCP/IP). A visual indicator is generated at the home network device indicative of the status of the network connection. For example, the visual indicator may be displayed using one or more light-emitting diodes on the home network device. In another example, the visual indicator may be displayed by configuring one or more web pages stored within the home network device.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 is a block diagram depicting an exemplary embodiment of a network device coupled between a wide area network (WAN) and a local area network (LAN);

FIG. 2 is a flow diagram depicting an exemplary embodiment of a process for monitoring network connectivity between a home network device and a network;

FIG. 3 is a block diagram depicting an exemplary embodiment of a home network system;

FIG. 4 is a flow diagram depicting another exemplary embodiment of a process for monitoring network connectivity between a home network device and a network; and

FIG. 5 is a flow diagram depicting yet another exemplary embodiment of a process for monitoring network connectivity between a home network device and a network.

To facilitate understanding, identical reference numerals have been used, wherever possible, to designate identical elements that are common to the figures.

### DETAILED DESCRIPTION OF THE INVENTION

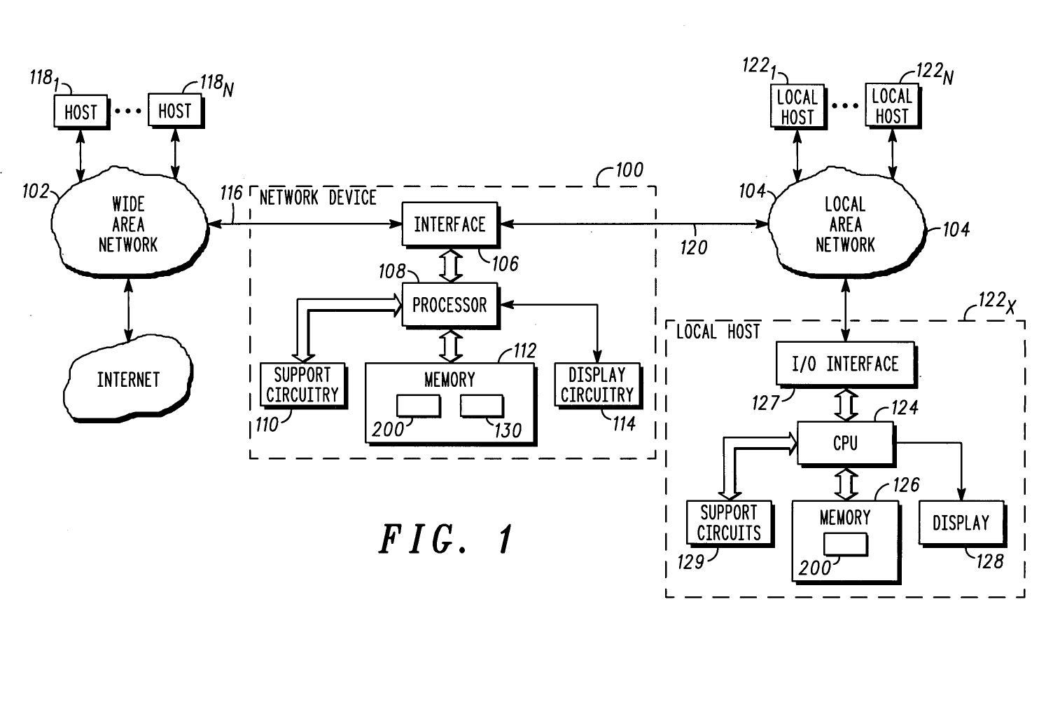

FIG. 1 is a block diagram depicting an exemplary embodiment of a network device 100 coupled between a wide area network (WAN) 102 and a local area network (LAN) 104. The network device 100 is suitable for operation in a home or small office/home office (SOHO) environment and may be referred to herein as a “home network device”. The network device 100 facilitates communication between the LAN 104 and the WAN 102. The WAN 102 illustratively comprises a plurality of hosts 118₁ through 118_{N}, where N is an integer (collectively referred to as hosts 118). The WAN 102 may be in communication with the Internet. The LAN 104 illustratively comprises a plurality of local hosts 122₁ through 122_{M}, where M is an integer (collectively referred to as local hosts 122). Although a plurality of local hosts 122 are shown, those skilled in the art will appreciate that the LAN 104 may comprise a single local host. Thus, the term LAN, as used herein, means a plurality of networked hosts or a single host coupled to the network device 100.

The network device 100 comprises an interface 106, a processor 108, support circuitry 110, a memory 112, and display circuitry 114. The processor 108 may be any type of microprocessor or microcontroller known in the art. The support circuitry 110 includes conventional cache, power supplies, clock circuits, data registers, and the like. In addition, the support circuitry 110 may include one or more of routing circuitry, modem circuitry, switching circuitry, bridging circuitry, and the like to facilitate operation of the interface 106. The memory 112 may include one or more of random access memory (RAM), read only memory (ROM), magneto-resistive read/write memory, optical read/write memory, cache memory, magnetic read/write memory, and the like, as well as signal-bearing media. The interface 106 enables communication between the LAN 104 and the WAN 102, and provides data to the processor 108.

In particular, the interface 106 is coupled to the WAN 102 via a data link 116. The data link 116 may comprise any type of wired transmission medium known in the art, such as coaxial cable, optical fiber, or twisted copper pair(s), or may comprise a wireless transmission medium. Data may be physically transmitted across the data link 116 using any type of transmission protocol known in the art, such as a 10Base-T, 100Base-T, 1000Base-T, xDSL, ISDN, DOCSIS, DS1, DS3, or frame relay transmission protocols, as well as various types of wireless transmission protocols known in the art (e.g., cellular or satellite).

The interface 106 is also coupled to the LAN 104 via a local data link 120. The local data link 120 may comprise any type of wired transmission medium known in the art, such as coaxial cable, optical fiber, or twisted pair cable, or may comprise a wireless transmission medium. Data may be physically transmitted across the data link 120 using any type of transmission protocol known in the art, such as a 10Base-T, 100Base-T, or 1000Base-T protocols, as well as various types of wireless transmission protocols known in the art, such as IEEE 802.11a, IEEE 802,11b, or IEEE 802.11g protocols.

local host 122_{X} of the LAN 104 may be a computer, illustratively comprising a central processing unit (CPU) 124, a memory 126, an input/output (I/O) interface 127, support circuits 129, and a display 128. The CPU 124 may be any type of microprocessor known in the art. The memory 126 may include one or more of random access memory (RAM), read only memory (ROM), magneto-resistive read/write memory, optical read/write memory, cache memory, magnetic read/write memory, and the like, as well as signal-bearing media. The I/O interface 127 may be directly coupled to the memory 126 or coupled through the CPU 124. The I/O interface 127 may be coupled to various input devices and output devices, such as a conventional keyboard, mouse, printer, display, and the like. The support circuitry 129 includes conventional cache, power supplies, clock circuits, data registers, and the like. The display 128 may be any type of visual display, such as a video monitor. The local host 122_{X} may be programmed with an operating system, such as OS/2, Java Virtual Machine, Linux, Solaris, Unix, Windows, Windows95, Windows98, Windows NT, and Windows2000, WindowsME, and WindowsXP, among other known platforms. At least a portion of an operating system may be disposed in the memory 128.

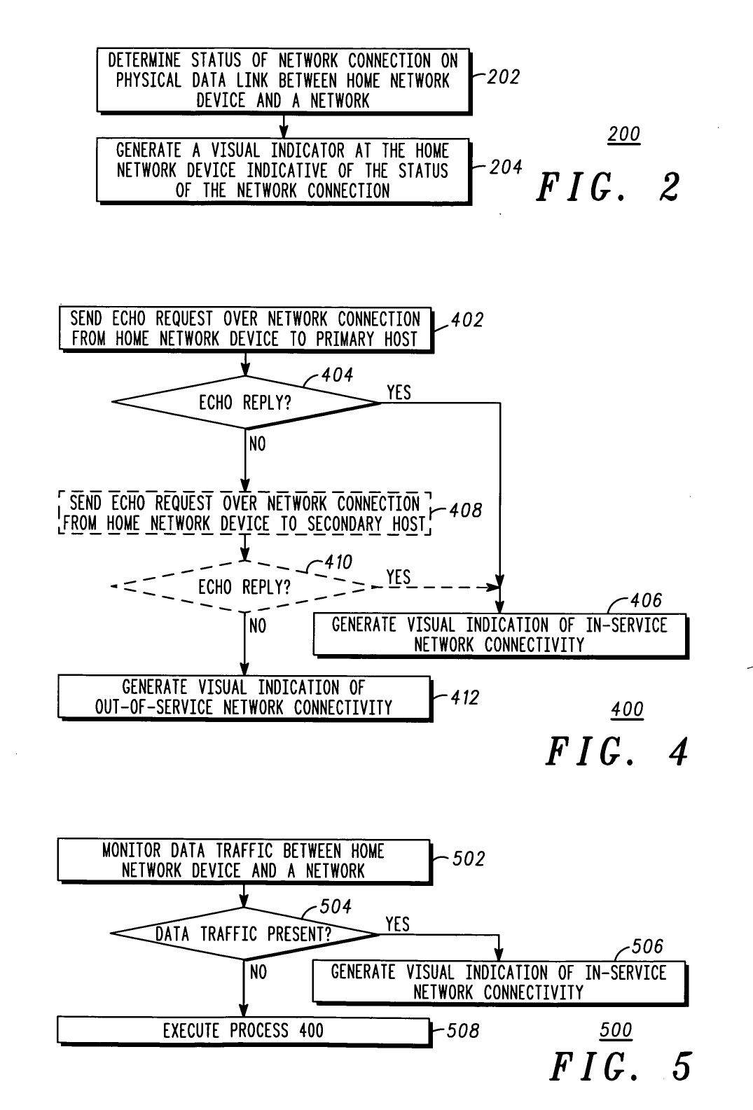

The network device 100 monitors network connectivity to networks with which the network device 100 communicates (e.g., WAN 102 or LAN 120). Notably, FIG. 2 is a flow diagram depicting an exemplary embodiment of a process 200 for monitoring network connectivity between a home network device and a network. The process 200 may be understood with simultaneous reference to FIG. 1. The process 200 begins at step 202, where status of a network connection on a physical data link between a home network device and a network is determined. For example, the network device 100 may determine the status of a network connection on the data link 116. In one embodiment, the network connection is implemented using transmission control protocol/internet protocol (TCP/IP). In another embodiment, the network device 100 may determine the status of a network connection on the local data link 120.

At step 204, a visual indicator is generated at the home network device that is indicative of the status of the network connection. For example, the network device 100 may use the display circuitry 114 to display the visual indication of network connectivity status. In one embodiment of the invention, the display circuitry 114 comprises at least one light-emitting diode (LED). In another embodiment of the invention, the network device 100 may configure the visual indicator for display on the display 128 of the local host 122_{X}. For example, the network device 100 may store one or more web pages 130 in the memory 112. The web pages 130 may be used to display and modify various attributes of the network device 100 on the display 128. Thus, the network device 100 may configure one or more of the web pages 130 to display the visual indication of network connectivity status.

Returning to FIG. 1, the memory 112 may store all or portions of one or more programs and/or data to implement the process 200. Alternatively, the process 200 may be implemented by one or more programs and/or data stored in the memory 126. Although the process 200 is disclosed as being implemented as a processor executing a software program, those skilled in the art will appreciate that the invention may be implemented in hardware, software, or a combination of hardware and software. Such implementations may include a number of processors independently executing various programs and dedicated hardware, such as application specific integrated circuits (ASICs).

FIG. 3 is a block diagram depicting an exemplary embodiment of a home network system 300. The home network system 300 comprises a router 302 and a modem 304. Although the router 302 and the modem 304 are illustratively shown as being separate elements, those skilled in the art will appreciate that the router 302 and the modem 304 may be combined into a single home network device. The modem 304 is coupled to an internet gateway 310 via a data link 307. The data link 307 may be any of the types of data links described above with respect to FIG. 1. The internet gateway 310 includes routers, switches, bridges, and the like of an internet service provider (ISP) that provides access to the Internet. The internet gateway 310 may be coupled to a domain name server (DNS).

The router 302 illustratively comprises a WAN interface 312, a LAN interface 314, control circuits 316, LEDs 318, and memory 320. The WAN interface 312 is coupled to the modem 304 via a data link 305. The LAN interface 314 is coupled to one or more computers 306 (e.g., two are shown) via a data link 309. The data link 305 and the data link 309 may be any of the types of data links described above with respect to FIG. 1. The LAN interface 314 and the WAN interface 312 facilitate communication between computers 306 and the Internet under control of the control circuits 316. The control circuits 316 provide the well-known function of routing communications among the computers 306 and between the computers 306 and the Internet. One of the computers 306 illustratively comprises a CPU 324, an I/O interface 322, supports circuits 328, memory 326, and a display 330. The components of computers 306 and their operation are substantially similar to those of the local host 122_{X} of FIG. 1 and are described above. The LEDs 318 comprise one or more light-emitting diodes. As described below, the LEDs 318 may be configured to display network connectivity status. The memory 320 may store one or more configuration web pages 332 for the router 302.

FIG. 4 is a flow diagram depicting another exemplary embodiment of a process 400 for monitoring network connectivity between a home network device and a network. The process 400 may be understood with simultaneous reference to FIG. 3. The process 400 begins at step 402, where an echo request is sent over a network connection from the home network device to a primary host on the network. For example, an echo request may be sent from the router 302 to the internet gateway 310 or the DNS 308. In one embodiment of the invention, the network connection is implemented using TCP/IP and the echo request is sent using an internet control message protocol (ICMP). That is, the router 302 “pings” either the internet gateway 310 of the DNS 308. The IP address of the primary host may be obtained via dynamic host control protocol (DHCP) when the home network system is initialized or registered with the internet gateway 310. Alternatively, the IP address of the primary host may be obtained from user configured data (e.g., using the web pages 332) if static IP allocation is employed.

At step 404, a determination is made as to whether an echo reply is received over the network connection at the home network device. For example, upon receiving an echo request, the internet gateway 310 or the DNS 308 will send an echo reply over the network connection to the router 302. In one embodiment of the invention, the echo reply is sent using ICMP. If the internet gateway 310 or the DNS 308 is out-of-service, or if the network connection is not functioning for some other reason, no echo reply will be returned to the router 302. If an echo reply is received, the process 400 proceeds to step 406, where a visual indication of in-service network connectivity is generated. For example, the router 302 may configure the LEDs 318 to display an in-service network indication. An exemplary configuration for the LEDs 318 is described below.

Alternatively, or in addition to configuring the LEDs 318, the router 302 may configure one or more of the web pages 332 stored within the memory 320 to display an in-service network indication. A visual indicator on a web page may comprise a graphical attribute, a textual attribute (e.g., “Internet OK” or “Internet out-of-service”), or both. For example, the visual indicator may be a graphical representation of the LEDs 318 on the router 302. In addition, the visual indicator on the web page may be static (e.g., the visual indicator will not change state unless the user clicks on a button the web page), or may be dynamic (e.g., the visual indicator will change state without user intervention). A dynamic visual indicator may be implemented using Javascript, for example. Utilizing the web pages 332 to display the network connectivity status reduces or eliminates the need for a user to physically examine the router 302.

In yet another embodiment, the router 302 may generate the visual indication using other types of electronic formats, besides the web pages 332. For example, the router 302 may deliver the network connectivity status right to the user's computer such that the visual indication appears on the display 330. In one embodiment, network connectivity status may be delivered to the computer 306 via a universal plug-and-play (UPnP) message so that the computer 306. This allows the router 302 to notify the user of network connectivity status without the user examining the LEDs 318 or logging onto the router 302 to view the configuration web pages 332. Those skilled in the art will appreciate that one or more of the above visual display embodiments (LEDs, configuration web pages, UPnP messages, etc) may be employed to display network connectivity status to the user.

If no echo reply is received, the process 400 proceeds to step 412, where a visual indication of out-of-service network connectivity is generated. Similar to the in-service visual indicator, the out-of-service visual indication may be shown using the LEDs 318, one or more of the web pages 332, electronic messages, or any combination thereof. The process 400 may be repeated periodically. For example, the process 400 may be a background task that periodically sends echo requests to the primary host in order to determine network connectivity status (e.g., once every ten seconds). The period of repetition may be selected as desired to reduce the amount of bandwidth used to check network connectivity.

In another embodiment of the invention, if an echo reply is not received at step 404 from the primary host, the process proceeds to optional step 408, where an echo request is sent over the network connection from the home network device to a secondary host on the network. For example, the primary host may be one of the internet gateway 310 and the DNS 308 and the secondary host may be the other of the internet gateway 310 and the DNS 308. Similar to the primary host, the IP address of the secondary host may be obtained via DHCP or user configured data. At optional step 410, a determination is made as to whether an echo reply has been received over the network connection from the secondary host at the home network device. If so, the process proceeds to step 406. Otherwise, the process proceeds to step 412. Checking network connectivity with a secondary host avoids false alarms. Thus, as long as one of the internet gateway 310 and the DNS 308 is in-service, the network connection may be deemed as in-service.

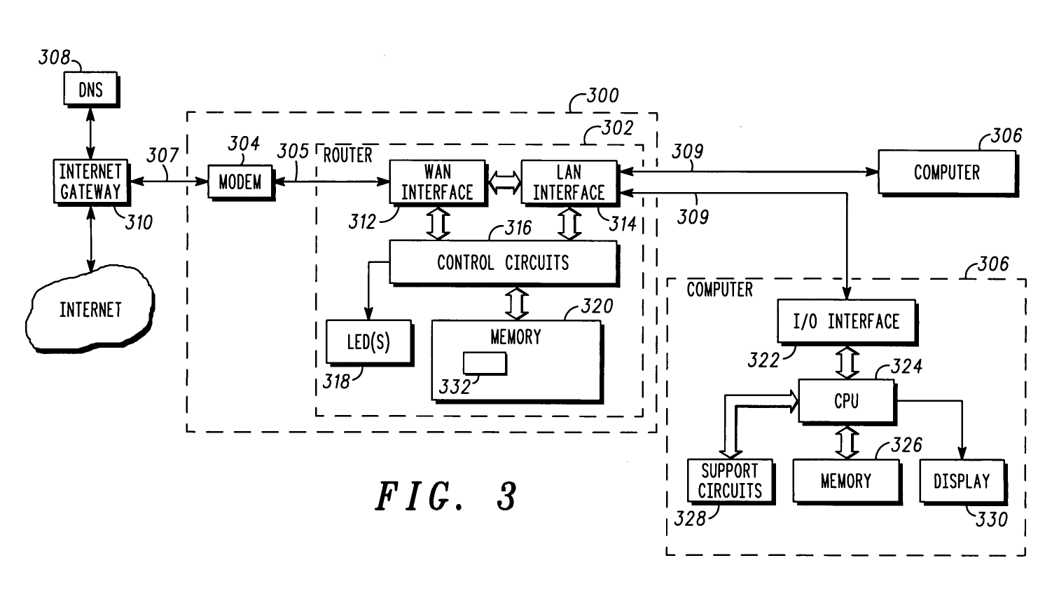

FIG. 5 is a flow diagram depicting yet another exemplary embodiment of a process 500 for monitoring network connectivity between a home network device and a network. The process 500 may be understood with simultaneous reference to FIG. 3. At step 502, data traffic between the home network device and a network is monitored. For example, data traffic between the router 302 and the internet gateway 310 may be monitored. In one embodiment, the data traffic comprises IP packets transmitted over a TCP/IP connection.

At step 504, a determination is made as to whether data traffic is present on the network connection. If so, the process proceeds to step 506, where a visual indication of in-service network connectivity is generated. The in-service indication of network connectivity may be displayed substantially as described above with respect to the process 400. If there is no data traffic present on the network connection, the process 500 proceeds to step 508, where the process 400 is executed. That is, if there is no data traffic, then the home network device will send an echo request to the primary host and/or the secondary host as described above to determine network connectivity. Monitoring data traffic on the network connection reduces wasted bandwidth by reducing the amount of echo requests to be transmitted to the internet gateway 310, the DNS 308, or both. If data traffic is being communicated over the network connection, then the network connection may be deemed as being in-service.

Returning to FIG. 3, the memory 320 may store all or portions of one or more programs and/or data to implement the process 300 and/or the process 400. Alternatively, the process 300 and/or the process 400 may be implemented by one or more programs and/or data stored in the memory 326 in one or more of the computers 306. Although the processes 300 and 400 are disclosed as being implemented as a processor or control circuit executing a software program, those skilled in the art will appreciate that the invention may be implemented in hardware, software, or a combination of hardware and software. Such implementations may include a number of processors or control circuits independently executing various programs and dedicated hardware, such as application specific integrated circuits (ASICs).

Although the process 300 and the process 400 have been described as being operative to determine network connectivity status on the WAN side of the router 302, those skilled in the art will appreciate that the processes 300 and 400 may be used to determine network connectivity on the LAN side of the router 302 (e.g., monitor network connectivity between the router 302 and one or more of the computers 306). Furthermore, although the processes 300 and 400 have been described with respect to a router-modem system, those skilled in the art will appreciate that the processes 300 and 400 may be used in any type of home network device or system, include a modem, a bridge, a switch, a router, or any combination thereof. For example, if a user employs only a single computer, then the user may dispense with the router and employ only a modem. Thus, the modem may employ the processes and methods described above to display network connectivity status to the user (e.g., the modem may include one or more LEDs to indicate network connectivity, or may store web pages to show network connectivity status). Moreover, although the home network system 300 has been shown as being separate from the computers 306, those skilled in the art will appreciated that the home network system 300 or any portion thereof may be part of a computer (e.g., a peripheral component interface (PCI) card plugged into the backplane of the computer).

The LEDs 318 may display network connectivity status in various configurations. In one embodiment of the invention, the LEDs 318 comprise a dual colored LED capable of displaying red, green, and amber (when both red and green are emitted). The dual colored LED may be labeled with the designation WAN for wide area network and can be used to indicate network connectivity status, as well as physical connectivity status if desired. For example, if the WAN interface 312 is not connected to the modem 304, or if the modem is not operational, the router 302 may cause the dual colored LED to be turned off. If the WAN interface 312 is connected to an active 10Base-T interface on the modem 304, the router 302 may cause the dual colored LED to be amber, which may be made to blink if data traffic is present. If the WAN interface 312 is connected to an active 100Base-T interface on the modem 304, then the router 302 may cause the dual colored LED to be green, which may be made to blink if data traffic is present. If the WAN interface 312 is disabled by the router configuration (e.g., through the web pages 332), then the router 302 may cause the dual colored LED to be red. If a determination has been made that the network connection is out-of-service, then the router 302 may cause the dual colored LED to blink in red. In another embodiment, the LEDs 318 may comprise two dual colored LEDs, one to indicate 10Base-T connectivity with the modem 304, and one to indicate 100Base-T connectivity with the modem 304. In such an embodiment, if the network connection is determined to be out-of-service, then the LEDs can be made to alternately blink, or simultaneously blink at a pre-defined frequency. Those skilled in the art will appreciate that the LEDs 318 may display network connectivity in many other configurations defined by at least one of a color configuration and a frequency of light emission.

The processes and methods described above may be implemented as a computer readable carrier. Program(s) of the computer readable carrier define functions of embodiments and can be contained on a variety of signal-bearing media, which include, but are not limited to: (i) information permanently stored on non-writable storage media (e.g., read-only memory devices within a computer such as CD-ROM or DVD-ROM disks readable by a CD-ROM drive or a DVD drive); (ii) alterable information stored on writable storage media (e.g., floppy disks within a diskette drive or hard-disk drive or read/writable CD or read/writable DVD); or (iii) information conveyed to a computer by a communications medium, such as through a computer or telephone network, including wireless communications. The latter embodiment specifically includes information downloaded from the Internet and other networks. Such signal-bearing media, when carrying computer-readable instructions that direct functions of the invention, represent embodiments of the invention.

While the foregoing is directed to illustrative embodiments of the present invention, other and further embodiments of the invention may be devised without departing from the basic scope thereof, and the scope thereof is determined by the claims that follow.

1. A method of monitoring network connectivity between a home network device and a network, comprising:
determining status of a network connection on a physical data link between said home network device and said network; and
generating a visual indicator at said home network device indicative of said status of said network connection.

2. The method of claim 1, wherein at least a portion of said network is a wide area network, and wherein said home network device is an access point to said wide area network for a local area network disposed in a small office/home office (SOHO) environment.

3. The method of claim 2, wherein said wide area network is in communication with the Internet.

4. The method of claim 2, wherein said network connection facilitates communication between said home network device and a host on said wide area network.

5. The method of claim 4, wherein said determining step comprises:
sending an echo request over said network connection from said home network device to said host; and
monitoring said network connection for an echo reply from said host in response to said echo request.

6. The method of claim 5, wherein said network connection is implemented using a transmission control protocol/internet protocol (TCP/IP), and wherein said echo request is sent using an internet control message protocol (ICMP).

7. The method of claim 5, further comprising periodically repeating said step of sending an echo request.

8. The method of claim 5, wherein said visual indicator is displayed in a first format in response to presence of said echo reply and in a second format in response to absence of said echo reply.

9. The method of claim 5, wherein said network connection facilitates communication between said home network device and another host on said wide area network, and wherein said determining step further comprises:
in response to absence of said echo reply, sending another echo request over said network connection from said home network device to said other host; and
monitoring said network connection for another echo reply from said other host in response to said other echo request.

10. The method of claim 9, wherein said visual indicator is displayed in a first format in response to presence of at least one of said echo reply and said other echo reply, and in a second format in response absence of both of said echo reply and said other echo reply.

11. The method of claim 9, wherein said host comprises one of an internet gateway and a domain name server (DNS), and said other host comprises the other of said internet gateway and said DNS.

12. The method of claim 4, wherein said step of determining comprises:
monitoring data traffic between said home network device and said host over said network connection;
in response to absence of said data traffic, sending an echo request over said network connection from said home network device to said host; and
in response to said echo request, monitoring said network connection for an echo reply from said host.

13. The method of claim 12, wherein said visual indicator is displayed in a first format in response to presence of at least one of said data traffic and said echo reply, and a second format in response to absence of both said data traffic and said echo reply.

14. The method of claim 2, further comprising:
determining status of a local network connection on a local physical data link between said home network device and said local area network; and
generating another visual indicator at said home network device indicative of said status of said local network connection.

15. The method of claim 1, wherein said home network device includes at least one light-emitting diode (LED), and wherein said step of generating comprises:
configuring said at least one LED to display said visual indicator.

16. The method of claim 15, wherein said visual indicator is defined by at least one of a color configuration of said at least one LED and a frequency of light emission of said at least one LED.

17. The method of claim 1, wherein said home network device includes at least one web page stored therein, and wherein step of generating comprises:
configuring said at least one web page to display said visual indicator.

18. The method of claim 17, wherein said visual indicator is defined by at least one of a graphical attribute, a textual attribute, and a static/dynamic attribute.

19. The method of claim 1, wherein said step of generating comprises:
creating an electronic message for transmission to a computer to display said visual indicator.

20. A home network device, comprising:
an interface for communicating with a network over a physical data link;
a processor for determining status of a network connection on said physical data link; and
display circuitry for displaying a visual indicator indicative of said status of said network connection.

21. The home network device of claim 20, wherein at least a portion of said network is a wide area network, and wherein said home network device is an access point to said wide area network for a local area network disposed in a small office/home office (SOHO) environment, and wherein said interface comprises:
a wide area network interface for communicating with said wide area network; and
a local area network interface for communicating with said local area network.

22. The home network device of claim 21, further comprising:
a router for routing communication between hosts on said wide area network interface and local hosts on said local area network interface over said network connection.

23. The home network device of claim 21, further comprising:
a modem for modulating and demodulating data on said physical data link.

24. The home network device of claim 20, wherein said display circuitry comprises at least one light emitting diode (LED) configured to display said visual indicator.

25. The home network device of claim 20, further comprising:
a memory for storing at least one web page;
wherein said processor is further configured to process said at least one web page to implement said visual indicator thereon.

26. A computer readable carrier including program instructions that instruct a computer to perform a method of:
determining status of a network connection on a physical data link between said home network device and said network; and
generating a visual indicator at said home network device indicative of said status of said network connection.

27. The computer readable carrier of claim 26, wherein at least a portion of said network is a wide area network, wherein said home network device is an access point to said wide area network for a local area network disposed in a small office/home office (SOHO) environment, said network connection facilitating communication between said home network device and a host on said wide area network, and wherein said determining step comprises:
sending an echo request over said network connection from said home network device to said host; and
monitoring said network connection for an echo reply from said host in response to said echo request.

28. A home network system, comprising:
a modem for communicating with a wide area network via a physical data link;
a router having a wide area network interface for communicating with said modem and a local area network interface for communicating with a local network;
a processor for determining status of a network connection on said physical data link; and
display circuitry for displaying a visual indicator indicative of said status of said network connection.

29. The home network system of claim 28, wherein said wide area network is in communication with the Internet, and wherein said router is an access point to the Internet for said local network.

30. The home network system of claim 28, wherein said display circuitry comprises at least one light emitting diode (LED) configured to display said visual indicator.
